(19) United States
(12) Patent Application Publication
(10) Pub. No.: US 2025/0023978 A1
(43) Pub. Date: Jan. 16, 2025

(54) DIGITAL HABIT TRAINER SYSTEM

(71) Applicant: Danyel Baker, Naples, FL (US)

(72) Inventor: Danyel Baker, Naples, FL (US)

(21) Appl. No.: 18/896,949

(22) Filed: Sep. 26, 2024

Related U.S. Application Data
(63) Continuation of application No. 18/117,116, filed on Mar. 3, 2023, now abandoned.
(60) Provisional application No. 63/316,146, filed on Mar. 3, 2022.

(51) Int. Cl. H04M 1/72466; H04M 1/72409; H04M 1/72451; H04M 1/72484

(52) U.S. Cl. CPC H04M 1/72466; H04M 1/724095; H04M 1/72451; H04M 1/72484

(57) ABSTRACT

The disclosure leverages electronic devices to establish habits in students by establishing a habit team that may include a student, a teacher, a parent, and others. The habit team includes numerous people, who are around the student at different times in the day, who all share the mutual goal of enriching the student through installation and reinforcement of positive habits. The habit team all receive reminders related to specific habits through electronic devices connected to a habit formation server. Habits can be initiated by a teacher, by a parent, and/or by the student. Time frames and reminders are established throughout a period sufficient to ensure habits are established. Communication across the various devices among the habit team ensures that team members do not act at cross-purposes and ensures that habit growing environments exist.

### CLAIM OF PRIORITY

The present application is a U.S. Non-Provisional Application claiming priority to U.S. patent application Ser. No. 18/117,116 filed Mar. 3, 2023, entitled “DIGITAL HABIT TRAINER SYSTEM”, which claimed priority to Provisional Application No. 63/316,146 filed Mar. 3, 2022, titled “DIGITAL HABIT TRAINER APPLICATION”, the disclosure of which is incorporated herein by reference in its entirety.

### FIELD OF THE EMBODIMENTS

The field of the invention and its embodiments relates to systems and methods for a digital habit trainer utilizing a team approach.

### BACKGROUND OF THE DISCLOSURE

Positive habit formation is a key to success for many people in all manner of different professions and their personal lives. However, habit formation can be challenging, especially given the number of distractions and randomness of events that many people have in their lives. As such, it can be difficult to remember actions and thoughts that a person wishes to engage in a repetitive manner so that they become positive habits. Moreover, there are times, such as when students are in a classroom, that one is distracted by engaging with the class, where it is easy to skip the positive reinforcement actions necessary to establish a habit. In the past, people might wear a rubber band or bracelet as a visual reminder, take notes in a journal for review at the end of the day or week, or engage in other systems or methods to try and remember the habits they wish to form or engage in. However, these prior systems and methods are passive and may not perform well for people with an active life or who are very busy.

One problem with many known habit creation solutions (see related art section below) is that they generally presume that an individual can change their habits on their own and fail to recognize common constraints on habit formation/adjustment. Stated simply, habits are not formed in a vacuum and often have a relationship to environmental factors, peer group factors, stress related reinforcers, and the like.

As a simple example, smoking is often considered a bad habit, which may relate to stress and that may have numerous known associated triggers. For instance, some people are particularly susceptible to smoking when around friends that smoke, smoking when drinking alcohol, and/or smoking when taking a short break during a hectic workday. Whatever the underlying triggers are, changing a habit often requires consistency across different circumstances, environments, and time periods.

In another example, some children (i.e., those with levels of attention-deficit/hyperactivity disorder or ADHD) may have a hard-time sitting in a classroom for extended lectures, which can result in such children being fidgety, restless, overly talkative, disruptive, and the like, which can lead to situation reinforced negative habits. These children may be able to overcome negative habits when not forced to sit quietly for extended periods, such as when in their home environment. Nonetheless, the school environment is somewhat “non-changeable” and negative habits tend to extend past discrete environments. Positive habits are often impeded or disrupted (so as not to properly form) due to time-related and environmentally related circumstances.

It would be beneficial to provide systems and methods for positive habit formation using mobile and wearable devices. Further, it would be beneficial to consider different environments and/or circumstances when attempting to effectuate positive habits. It would be further beneficial to provide a supporting interpersonal infrastructure able to consistently help an individual form positive habits.

### RELATED ART

US2014/0363797A1 discloses wellness-related directives applicable to a user. Conflicts between directives can be determined. The directives can be presented via a wearable device.

US2019/0027052 discloses an electronic system for facilitating the establishment of habits. The disclosure includes an electronically stored library containing descriptions of multiple habits, a computer for searching the library, a screen for electronically displaying and selecting the habits, and computer for assisting the user in the formation of a selected habit.

US2004/00184A1 discloses an introductory adult set of instructions for an adult to apply a step-by-step life experiences and good habits and activities and knowledge learning program for a child. Exercises and activities are performed by the child as instructed by the adult. Each exercise and activity include an adult guide for when, how, and why to apply them.

US2015/0364057A1 discloses allowing health and lifestyle improvements using a system that helps a user plan strategies for improving and/or maintaining his/her wellness, health, and lifestyle. The disclosure helps the person track his/her compliance with the strategies.

US2023/0419353A1 provides habit forming software, which includes use of an avatar, habit projects, categorizing habits, and awarding points (e.g., gamification).

Other references of note include US2022/0351830A1, US2023/0260414A1, US2023/0410676A1, US2017/0011641A1, US2017/0208021A1, US2022/0244818A1, and US2022/0375569A1.

### SUMMARY OF THE EMBODIMENTS

Having healthy habits and a healthy lifestyle is incredibly important for both your physical and mental well-being. It can impact everything from your energy levels to your risk of chronic diseases. An establishment of positive habits is particularly applicable to children, who can receive vast, lifelong, significant benefits from even small changes, such as those that improve a child's academic, physical, and/or emotional state. Installing positive habits often relates to consistency, which is challenging given the different environments a child finds themselves in.

Embodiments of the disclosure leverage electronic devices to establish habits in students (children and otherwise) by establishing a habit team that may include a student, a teacher, a parent, and others. The habit team includes numerous people, who are around the student at different times in the day, who all share the mutual goal of enriching the student through installation and reinforcement of positive habits. The habit team all receive reminders related to specific habits through electronic devices connected to a habit formation server. Habits can be initiated by a teacher, by a parent, and/or by the student. Time frames and reminders are established throughout a period sufficient to ensure habits are established. Communication across the various devices among the habit team ensures that team members do not act at cross-purposes and ensures that habit growing environments exist.

To elaborate, numerous phone apps may exist (see related art) that encourage through a mobile device a student to take an action at a specific time. A classroom, however, may restrict the student's access to their mobile device at this time and/or may not permit the habit-formation action to occur. For instance, a reminder to a student to drink water (proper hydration being a positive habit) at 10:00 AM may be unhelpful to a student in a classroom between 9:50 and 11:30. Teachers may, inherently, not permit students to leave a classroom, to drink water in a classroom, to look at their phones, etc. at this time. In embodiments, a set of teachers working with parents and students will inherently coordinate the “habit formation” to occur outside of class (such as 9:40 and not 10:00) and/or make other reasonable accommodation transparently. For example, while a habit is forming, a teacher may automatically permit that specific student to quietly leave class, or to drink from a water bottle at 10:00, without imposing negative actions on the student. As noted from the example above, it can be important to involve a habit team, coordinated via electronic mechanisms, to increase the odds and minimize the impediments to forming positive habits.

One aspect of the disclosure includes a system for providing digital habit reminders via a user computing device is disclosed including at least one user computing device in operable connection with a user network. In embodiments, reminders specific to a habit formation target can be coordinated among multiple devices of the targets habit team. For instance, the target can be a student and the habit team can include the student, one or more teachers, and one or more parents. Other teams can exist, such as an employee, a set of coworkers, a spouse, and the like. Health related habits can involve a personal trainer, a medical team, a physician, a psychologist, a support group, and the like. Academic related habits can involve a school, a teacher, a support group, and the like. Different groups or teams can be tailored depending on the habit being developed and/or the time-sensitive activities/environments that a habit training individual (i.e., habit trainee) finds themselves within. A habit trainer can establish habits for the trainee. Habit trainers include teachers, parents, mental health professionals, life coaches, sports coaches, fitness instructors, and the like.

In embodiments, an application server, such as one running a backend program supporting habit formation and coordination among devices of a habit team, is in operable communication with the user network to host an application system for providing digital habit reminders. These reminders and/or devices may be divergent. For example, a mobile device may not be available to receive reminders when a student is attending class, in which case a reminder can be quietly and discretely conveyed to a device used by the teacher supervising the student at that time. The application system includes a user interface module for providing access to the application program through the user computing device (used by the habit forming individual and/or that individual's habit team). A habit module is in communication with the habit server and/or habit facilitating backend application server to permit input of at least one habit and to deliver, via a communication module, an alert associated with the at least one habit to an appropriate computing device. Selection of a computing device can be time sensitive. A timing module permits the input of a time interval associated with each of the at least one habits, via the communication module, at the time interval.

The systems and methods described herein provide a habit trainer application for a user device that can provide reminders for positive habit training, particularly in the time management, health and wellness, and other industries. The habits can be reinforced and/or facilitated by a group of concerned people called a habit team, which may include a student, a set of teachers(s), and one or more parents. Other groups or habit teams are contemplated. A set of computing devices accessed by the team can coordinate with the habit server. Wearable devices may also be involved in this set of computing devices accessed by the habit team. In embodiments, the habit server and/or set of devices, systems, and methods can include incorporating a habit trainer application that generates a habit block by allowing a user to set a habit notification word, a time, interval parameters, and the like.

One aspect of the disclosure includes a habit system for facilitating positive habit formation by students using a habit team approach. The system includes a habit server and a set of student computing devices. The habit server includes a processor, a memory, a data store, and computer code stored on the data store configured to be executed by the processor. Such execution results in establishment of a set of user accounts, each account being associated with an account holder, a computing device running habit code designed for interactions with the habit server, and security account access credentials unique to the respective one of the user accounts. The user accounts include student accounts, teacher accounts, and parent accounts. Each teacher account is cross indexed and authorized access to a teacher subset of the student accounts comprising students of classes the teacher provides. Each parent account is cross indexed and authorized access to a parent subset of the student accounts associated with a child of the respective parent.

A set of habits are defined for students to work upon. Each of the habits includes a daily habit training time window, a frequency in which the respective one of the habits is to be trained within the habit training time window, and a habit name. At least one of the habits is defined by the teacher for each of the teacher subset of student accounts. The student computing devices are each a mobile device unique to one of the students in the teacher subset. Each is configured to provide reminders for the respective one of the habits consistent with the frequency and the habit training time window. Each of the student computing devices is registered with the habit server and is associated with a respective one of the student accounts. Each reminder is associated with a confirmation that must be timely entered responsive to each of the reminders to be affirmed as successfully completed by the respective student. Real time results from the habit server regarding whether the reminders have been successfully completed by the students are accessible from the teacher accounts for the teacher subset and are accessible from the parent accounts for the parent subset.

In one embodiment, the habit server is configured to communicate the real-time results to at least one school computer system utilized by the teacher within which student grades are maintained for the students including the subset that are taught by the teacher. The real-time results are a factor that automatically affects grades per the student grades of the school computer system of the students of the teacher subset. The habits established by the teacher are academic habits desirable for students to possess for improved academic performance relative to students lacking such desirable academic habits. The student computing devices comprise smart phones of the students as well as wearable computing devices, such as smart watches. In one embodiment, a wearable computing device can obtain physiological data from a wearer, which is reported to the habit server and associated with habit training. The habit server can include an AI module configured to enable natural language processing via at least one chatbot interface. Each of the student computing devices comprise a habit application running on the respective computing devices providing natural language input and output dependent upon processing of the AI module and the chatbot interface. In one embodiment, the chatbot interface permits questions of a habit knowledgebase maintained by the habit system for the habits established by the teachers. The knowledgebase comprises machine learned and internet updated information for the habits established by the teachers. The AI module is an interface module that is made available to teachers utilizing the teacher accounts, parents using the parent accounts, and students utilizing the student accounts, each of which leverage a common habit knowledgebase trained for the AI module using machine learning (ML) and automated internet knowledge acquisitions. In one embodiment, at least a portion of the reminders occur during a classroom period within which the subset of students is in the classroom of the teacher, wherein software executing on each of the student computing devices permits interactions for the limited purpose oof responding to reminders occurring during the classroom period. Other interactions during the classroom period are disabled or flagged as improper and conveyed to the habit server and available to the teacher via the respective teacher account. At least a portion of the students are public school students having a school acknowledged accommodation due to a student specific challenge. A portion of students have an accommodation related habit defined within the habit server by a school administrator or school mental health professional. The teacher is apprised of the accommodation related habit to an exist applicable to a classroom being taught by the teacher needs to be aware to facilitate the accommodation. In one embodiment, the habits created by the teacher must be approved by the respective parents prior to such habits being applied to the respective students via the student computing devices.

In one aspect, the systems and methods described herein allow for the user to establish a habit training regimen that allows for the training of habits and/or the untraining of habits. Any member of the habit team may initiate and/or assist with the training regimen. In one aspect, users may activate and/or deactivate one or more habits or groups of habits. In such, the user may selectively reactivate previously deactivated habits. A user may be comprised of Students and/or Athletes. A subset of Users may be comprised of Parents and/or Teachers.

The habit server and related application(s) may also utilize an interval system to send an alert, such as the habit notification word, to the user. The alert is a notification on and/or to a mobile or electronic device, or set thereof, such as a smartwatch and/or a smartphone. The notification can include a sound alert or be silent, with or without vibration of the electronic device. The notification presents a notification screen with an alert dismiss button. For each habit block, the application tracks how many days the user has been training the corresponding habit. When a user and/or habit team feels that a habit has been formed or mastered, the user/team can remove or deactivate the corresponding habit block. The user can reactivate a previously deactivated habit block. In embodiments, specific habits can have related wearable sensors associated. For example, a habit target prone to stress/PTSD/etc. may wear a watch that monitors that user's heart rate. A teacher or other member of the habit team may be informed when a wearer's heart rate is elevated past a designated threshold so that the team member may assist/be aware that time to introduce a “calming” habit or routine is occurring. In absence of the discrete formation of the habit team, even well-meaning individuals may misinterpret a student's actions, which can result in a negative feedback loop impeding positive habit formation.

In one embodiment, the habit server and/or related application has an interface with a maximum number of habit blocks appearing per page. For example, the application can limit the habit blocks per page up to 4 habit blocks. When a user has more than the maximum number of habit blocks per page (e.g., more than 4 habit blocks), new pages are generated until all habit blocks have a corresponding page. The user can switch between pages to select a particular habit by clicking the habit block corresponding to the particular habit. Habit team members, such as a teacher, many only receive habit related messages on their device(s) within restricted time frames, such as when a specific student is in that teacher's classroom. Otherwise, the habit specific information is not communicated to that teacher. For example, an overall system may include accommodations for numerous students due to known disabilities and/or challenges, yet each teacher may only be aware of the situation when necessary. This ensures a team approach without penalizing a suffering student from increased and unmerited attention, which in and of itself can be a detriment to that student.

Other objects and advantages of the various embodiments of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

FIG. 1 shows a habit forming system including a server and connected devices in accordance with embodiments of the disclosure.

FIG. 2 shows a computing system running a habit application in accordance with embodiments of the disclosure.

FIG. 3A shows a user interface for habit training in accordance with embodiments of the disclosure.

FIG. 3B shows a user interface for creating a new habit entry in accordance with embodiments of the disclosure.

FIG. 3C shows a user interface for a daily habit reminder in accordance with embodiments of the disclosure.

FIG. 4A shows a user interface for a habit task in accordance with embodiments of the disclosure.

FIG. 4B shows a user interface for a habit task after changes were made in accordance with embodiments of the disclosure.

FIG. 5A shows a user interface of a smart watch for a posture habit in accordance with embodiments of the disclosure.

FIG. 5B shows a user interface of a smart watch for habit notifications in accordance with embodiments of the disclosure.

FIG. 5C shows a user interface of a smart watch for a current action needed for a habit in accordance with embodiments of the disclosure.

FIG. 5D shows a user interface of a watch for multiple habits in accordance with embodiments of the disclosure.

FIG. 6A shows a flow for a team approach to habit formation in accordance with embodiments of the disclosure.

FIG. 6B shows a diagram for establishing accounts for all habit team members in accordance with embodiments of the disclosure.

FIG. 6C shows different roles or routes for habit team members in accordance with embodiments of the disclosure.

FIG. 6D shows an overview of the teacher route for the habit application in accordance with embodiments of the disclosure.

FIG. 6E shows various teacher options/screens for habit tracking/editing in accordance with embodiments of the disclosure.

FIG. 6F shows an overview of the student route for the habit application in accordance with embodiments of the disclosure.

FIG. 6G shows various student options/screens for habit tracking/editing in accordance with embodiments of the disclosure.

FIG. 6H shows an overview of the parent route for the habit application in accordance with embodiments of the disclosure.

FIG. 6I shows various parent options/screens for habit tracking/editing in accordance with embodiments of the disclosure.

FIG. 7A shows a table of habit server features/screens/functions and related user requirements in accordance with embodiments of the disclosure.

FIG. 7B shows another table of habit server features/screens/functions and related user requirements in accordance with embodiments of the disclosure.

FIG. 7C shows yet another table of habit server features/screens/functions and related user requirements in accordance with embodiments of the disclosure.

### DESCRIPTION OF THE PREFERRED EMBODIMENTS

The preferred embodiments of the present invention will now be described with reference to the drawings. Identical elements in the various figures may be identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

The phrase “and/or,” as used herein in the specification and in the claims, should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Embodiments of the disclosure focus upon habits with a specific emphasis toward positive habit formation and utilizing a habit team with divergent roles at different times of day depending on routines and schedules of the habit former (i.e., habit trainee). In general, the embodiments provided herein relate to a habit training system for a user device that can provide reminders for positive habit training, particularly in the time management, health and wellness, and other industries. Habit information, messages, and other communication may be provided securely and discrete upon different computing devices used by different members of the habit team, which together supports positive habit formation. The system can include incorporating a habit trainer application program that generates a habit block by allowing a user (i.e., habit former or habit trainee) to set a habit notification word, a time frame, and interval parameters. The application program also uses an interval system to send an alert, such as the habit notification word, to the user. In embodiments, buy-in is achieved from each of the habit team, which share a common goal and/or understanding. For example, a teacher on the habit team may indicate accommodations are available during classroom hours to facilitate the formation of a student's habit, where the accommodations can be designed to be minimally intrusive to the classroom.

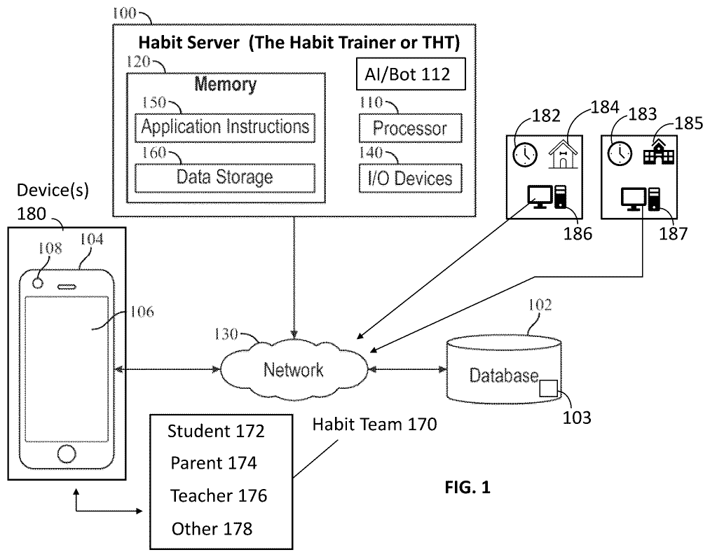

With reference to FIG. 1, a habit server 110 is connected to a set of devices 180 and one or more databases 102 via a network 130. The devices 180 are used by different habit team 170 members, where each team 170 member may have a set of devices 180 that are involved in habit formation, such as a mobile telephone, a notebook computer, one or more wearable devices, and the like. In one embodiment a habit former can be a high-school student 172 and the habit team 170 can include a set of parents 174, a set of teachers 176, and others 178, such as a coach, a counselor, a peer support lead, and the like. Interface interactions can use artificial intelligence 112 features, which includes natural language understanding (NLU) interactions, machine learning (ML) tailored for the habit trainee, and that leverages a significant knowledgebase 103 specific to the habit being formed and best practices thereof. In one embodiment, user interactions can be facilitated through a bot, which can be referred to as BUDDI AI or just BUDDI.

In embodiments, BUDDI can be implemented as a virtual assistant and chatbot that is aimed at harnessing the power of artificial intelligence to revolutionize education and make it a more personal experience for each student based on their learning style and needs, establishing stronger teacher student-parent partnerships and increasing the quality of child education. BUDDI can be through of as an artificially intelligent robot, avatar, and friend created by to a virtual assistant, personal training, confidant, and companion. BUDDI can take on different attributes, styles, personalities, gender, and the like, which can vary by age and preference of the user interacting with the bot (112).

Different habit teams of 170 members can be responsible for facilitating the habit formation process at different times 182, 183, locations 184, 185, via different integrated systems. For example, a high-school student 172 will attend classes at a school 185 that have designated start-end times 183. During these times (e.g., class periods), different teaches 176 having different devices 187 will be physically supervising the student 172. Habit specific messages can be conveyed to an appropriate teacher 176 via an accessible device 177 at a suitable time 183, as determined by the habit server 100. At other times 182, a student 174 may be in a house 184 or apartment of a parent 174 or guardian. Shared custody situations of divided households can be accommodated with suitable locations 184, devices 186 for respective parents 174 as designed by server 100. Others 178 on the habit team 170 can have times and devices associated with a reoccurring schedule, which can be tracked and maintained by the server 100 in embodiments.

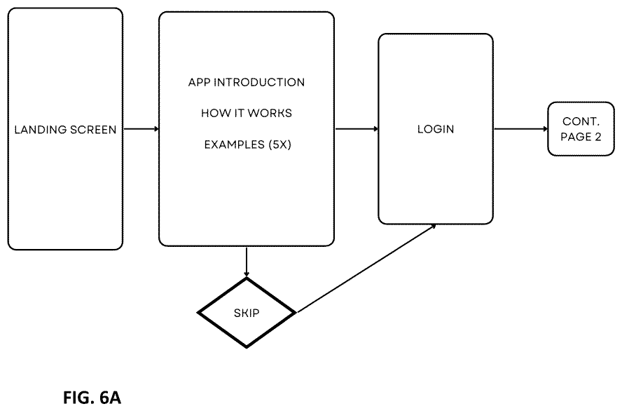

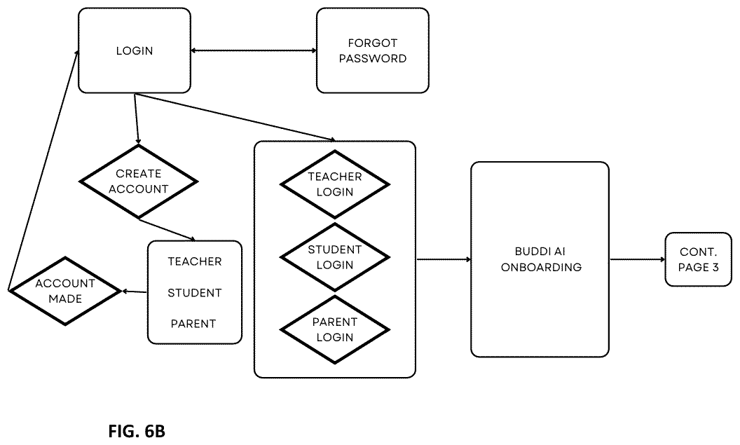

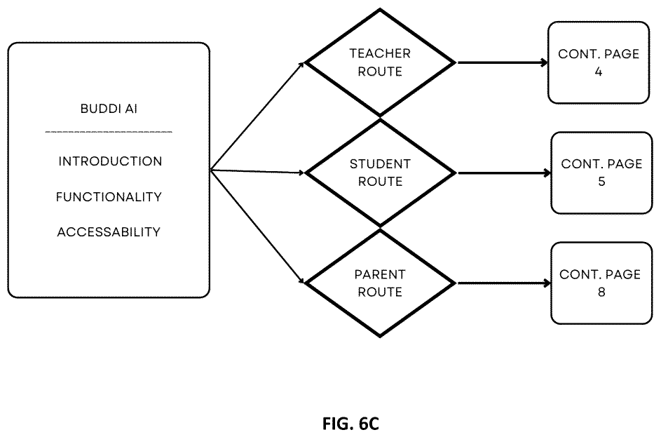

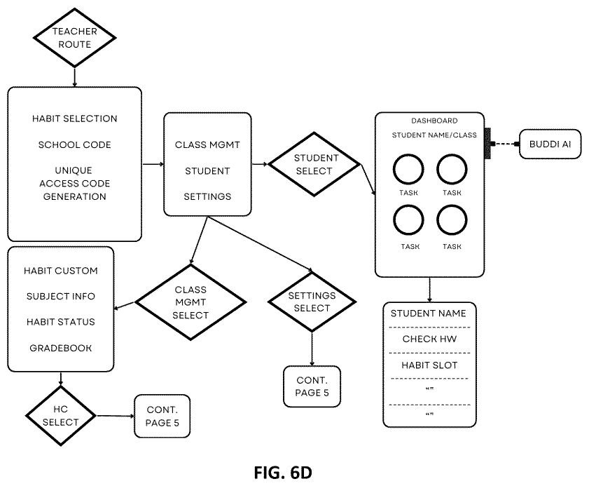

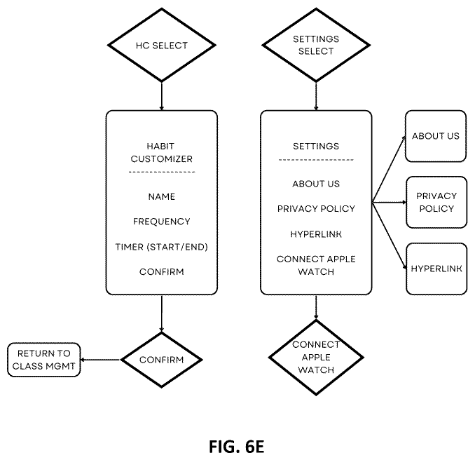

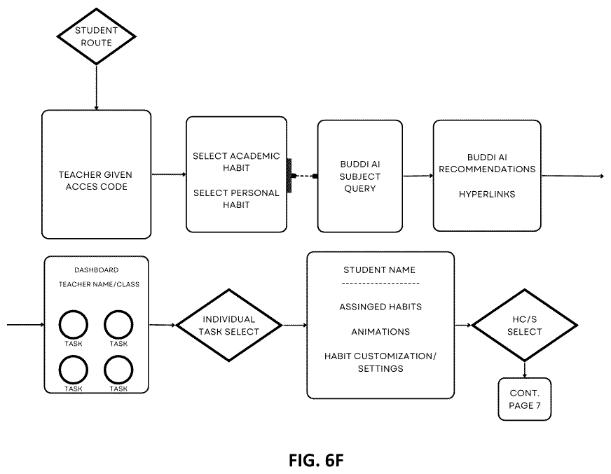

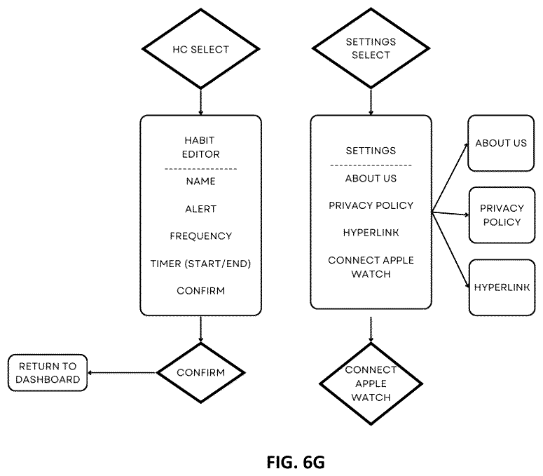

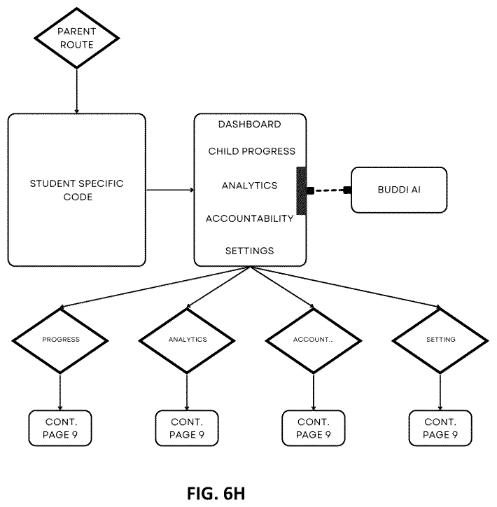

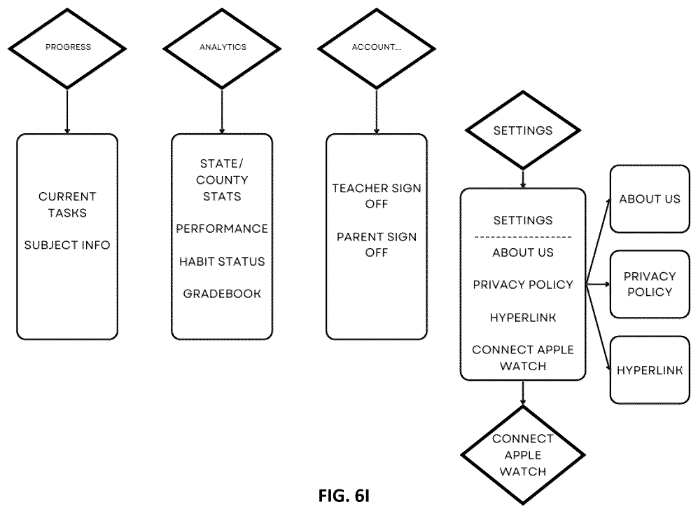

With reference to FIG. 6A, a user forming a habit can utilize an app installed on a device 180, such as a smart phone. The app may have a landing screen and an introduction/help portion, which may be skipped for users familiar with the app. The app may require the user to login, which integrates security features. With reference to FIG. 6B, other habit team 170 members also log-in their devices with the habit server 100. Of course, accounts are established for each. A single account may be used by a teacher for multiple students. Similarly, parents with multiple children and/or their own account, so multiple ones are unnecessary. In short, each team member 170 or other user should have one account, where a habit creation account, which is referenced as the student account, is the primary one, enabling privileges on information specific to the student account. The AI onboarding process can include referencing the knowledgebase 103 to establish a tailored habit forming approach with customized bot(s).

With reference to FIG. 6C, each team member 170 can have AI interactive features enabled. Further, different team members 170 have different routes, responsibilities, views, permissions, etc. For example, a teacher 176 can be an establishing entity or partner for study specific habits preferred for that teacher's class. Compliance with the study habit may increase that student's 172 grade in the class. In embodiments, class, school, district, or other hierarchical unit of education may be integrated with the habit server 100 and with an educational curriculum.

With reference to FIG. 6D, the teacher route can include an ability for teachers 176 to select different habits for different ones of their students 172. A school code can be provided when appropriate. In embodiments, educational funding may be used to support habit server 100 and the school is granted a code for a subscription fee. In another embodiment, the school code can be used to establish and enforce school specific policies regarding use of habit server 100 by the teacher(s) 170. For example, in embodiments, students on academic or behavioral probation may be able to participate in the habit program to lower the duration or severity of the probation. In another embodiment, students with disabilities or individualized education plans can have specific habits established with server 100 per school policy. For example, an autistic student known to have a tendency towards autistic meltdowns when overly stimulated may exhibit heightened heart rates during periods leading up to a meltdown. An individualized plan can indicate cool down accommodations are approved, which may be triggered by a wearable (a student watch indicating heightened heartrate), which conveys a “habit” notification to a classroom teacher 176 that the autistic child should be soothed, which can involve permitting the student 172 to briefly go to a quiet environment. The above example, focusing on disabilities and known habits mental health professionals attempt to use to mitigate effects of these disabilities, and shows how the habit server 100 may be useful in providing good, healthy habits. The communications infrastructure of the habit server 100, the devices 180, and the teams 170 is capable to being leveraged to facilitate accommodations in a minimally obtrusive, health way, which is a task schools that are required to provide such accommodations often struggle with.

As shown by FIG. 6D, teacher 176 can be presented with a class management screen, which lists the students in specific classes and habits being tracked/applied. Different settings can change the structure of such a screen, so that a teacher can view all students associated with a specific habit, for example, Selection of a class management screen/function may provide a way to establish a new habit, to customize a habit, may provide information regarding the student and the habit, may provide a progress status per habit formation, and can be integrated into a teachers gradebook. Individual students can be selected, which can show tasks assigned to the student for habit formation(s). These tasks can be those established by the teacher 176, those the teacher 176 is permitted to see, and/or those having a time element occurring within the teacher's classroom, which the teacher 176 is to facilitate. Habit specific homework can be assigned and checked by a teacher 176 in embodiments. AI features, including a chatbot designed for the teacher 176 can be integrated in embodiments.

With reference to FIG. 6E, customizations of habits established per the teacher route include naming the habit, establishing a habit frequency, placing a start and end time for habit establishment, and the like. Privacy settings and links elaborating upon the same can be integrated into the setting of the teaching route. Teachers 176 can integrate messages and/or the app with a wearable device, such as an APPLE watch and/or an ANDROID wearable.

With reference to FIG. 6F, an embodiment is shown where a student is provided with an access code, provided by a school/teacher. Other embodiments exist, where a student may initiate their own habits without being conveyed a code. Available of a code in embodiments emphasizes how the habit system can be advantageously integrated within an academic or work environment. A student, once logging in, may establish one or more academic and personal habits to build. In embodiments, suggestions and/or help can be provided via a chatbot, an AI enhanced interface, or BUDDI. Various tasks to complete for each habit are shown in a dashboard. For any selected task, specifics are shown, such as details of the habits, setting interactive customizations, and establishing animations (if available). In embodiments, habits available via this process can be gamified, so that successful completion of habit related tasks earns points, accolades, etc. As seen by FIG. 6G, a student can edit habit alerts, alert types, frequencies, timing, and the like. Habit edits may be controlled by a habit establisher, where all habit team 170 members are notified of changes and some habit team members 170 may be required to approve changes and/or granted editing authority. Privacy settings, connectively options, and the like shown in settings are consistent with those of the teacher route.

The parent route is shown by FIG. 6H, where a student specific code is received for account establishment/access in embodiments. In other embodiments, parents can initiate a habit for their child, which one or more teachers can help facilitate. For example, if a student is prone to be dehydrated in GYM, a teacher 170 in a prior class can authorize/permit student 172 hydration prior to the gym class, which is a possible, hydration-related, parent initiated, habit entry. Parent 174 is provided with a dashboard showing child progress of each assigned/associated habit. Various accountability features and/or parental approval options exist. For example, a school initiated habit may require parental approval and/or participation prior to being implemented. AI features, including chatbot ones, are available for the parent route.

With reference to FIG. 6I, a parent can view progress on each task and related information, such as the purpose of the habit task, the benefits of the habit being installed, and the like. Some options to adjust the habit and/or the formation process can be provided in embodiment. Parents 174 (and teachers/students/administrators) may be presented with analytics showing their student's progress compared to others on a state/county/local level. Gradebook entries, milestones, upcoming tasks, etc. may be shown. With regard to account establishment, a parent and teacher both may be required to sign-off prior to any team 170 habit being formed/approved. Each team 170 member will have an account, through which information is provided. Settings regarding privacy and connectivity available within the parent route are consistent with that of the teacher route, as shown.

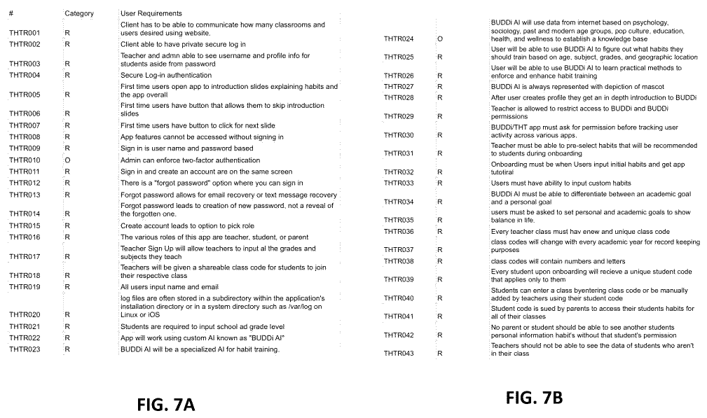

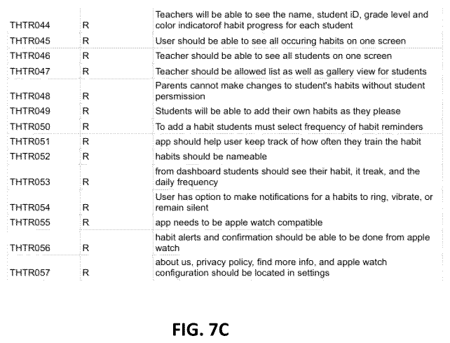

FIGS. 7A, 7B, and 7C provide some key variables, features, and functions performed by embodiments of the habit system 100. Each unique one is labeled with table unique identifier, a category code, and a set of requirements needed by the system 100. A client in these figures represents team 170 member with system 100 access via one or more devices 180. Application screens may exist via browser served pages. That is, even when apps exist for features, backup access via a standard internet browser can be available. Requirements exist for registration, account establishment, and information coordination among a set of accounts of habit team 170 members. Password recovery, two-factor security, and the like can be implemented. Embodiment, contemplate a school driven approach, where a school may have a subscription for the habit server 100 conveyed to students 172 and parents 174. In a preferred embodiment, manual variables may be manually recorded and tracked. Manual variable may comprise, Age, Weight, Height, Grade Level, Current Sport(s), and Medication/Medical History of a user. In a preferred embodiment, calculated variables may be automatically recorded and tracked. Such calculated variable may comprise Sleep Duration and Disturbance, BMI, Average Heart Rate, Blood Oxygen Level, Average Calories Burned Per Day, Average Steps Per Day, and Temperature.

Returning to FIG. 1, a system architecture diagram is illustrated that includes computer system 100 or habit server, which can be utilized to provide and/or execute the processes described herein in various embodiments. The computer system 100 can be comprised of a standalone computer or mobile computing device, a mainframe computer system, a workstation, a network computer, a desktop computer, a laptop, a tablet, a smartphone, a videogame console, an eBook reader or dedicated digital reader device, or the like. The computer system 100 includes one or more processors 110 coupled to a memory 120 via an input/output (I/O) interface. Computer system 100 may further include a network interface to communicate with the network 130. One or more input/output (I/O) devices 100, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface. In many embodiments, computer system 100 can be a server that is fully automated or partially automated and may operate with minimal or no interaction or human input during processes described herein. As such, many embodiments of the processes described herein can be fully automated or partially automated. In instances where a server is provided, connection through network 130 can allow the server to store information in one or more databases that can be used for adaptive learning, artificial intelligence operations, machine learning, or others. Example databases include lesson database(s), client database(s), and others.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel storage area networks (SANs), or via any other suitable type of network and/or protocol.

The memory 120 may include application instructions 150, configured to implement certain embodiments described herein, and at least one database or data storage 160, comprising various data accessible by the application instructions 150. In at least one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in random access memory (RAM), flash memory, read-only memory (ROM) memory, erasable programmable read-only memory (EPROM) memory, electrically erasable programmable read only memory (EEPROM) memory, registers, a hard disk, a solid-state drive (SSD), hybrid drive, dual-drive, a removable disk, a compact disc read-only memory (CD-ROM), digital versatile disc (DVD), high definition digital versatile disc (HD DVD), or any other form of non-transitory storage medium known in the art or later developed. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, BLUETOOTH, WI-FI, microwave, or others, then the coaxial cable, fiber optic cable, twisted pair, DSL, or wireless technologies such as infrared, radio, BLUETOOTH, Wi-Fi, microwave, or others can be included in the definition of medium. “Disk” and “disc,” as used herein, include compact disc (CD), laser disc, optical disc, digital versatile disc (DVD), floppy disk, and Blu-ray disc or others where disks usually reproduce data magnetically, while discs usually reproduce data optically with lasers. Combinations of the above should also be included within the scope of computer-readable media.

It should be understood by those in the art that computer system 100 also includes power components that are operably coupled such that the system is operable. This can include one or more batteries if the computer system 100 is mobile.

In some embodiments, the system is world-wide-web (www) accessible and/or based, and a network server can include a web server delivering HTML, XML, etc., web pages to the computing devices. In other embodiments, a client-server architecture may be implemented, in which a network server executes enterprise and custom software, exchanging data with custom client applications running on the computing device 100.

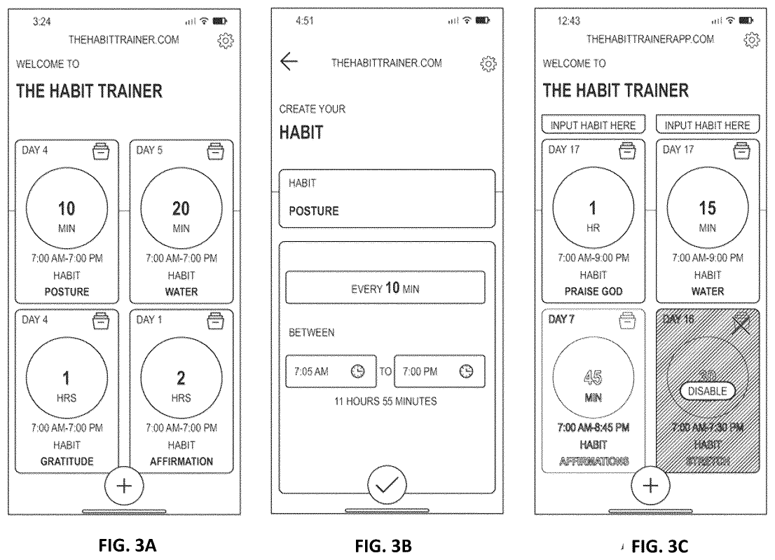

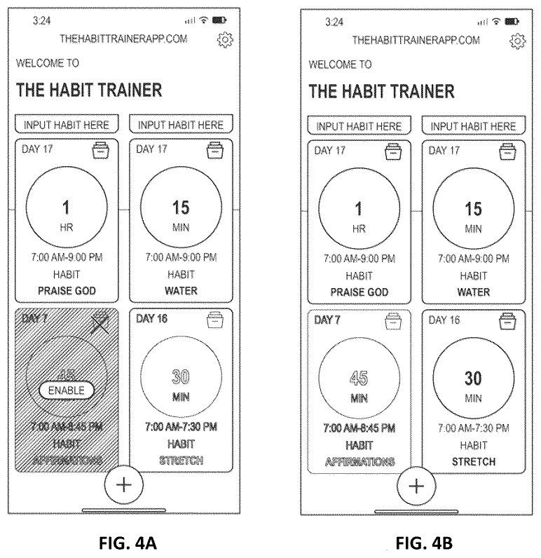

FIGS. 3A-3C and 4A, 4B illustrate a user interface screen of a mobile application, according to some embodiments.

As shown in FIG. 3A, a user interface screen of a mobile application can include at least one habit training overview display. In the example embodiment, four such overview displays are shown, one for a posture habit training overview display, one for a water habit training overview display, one for a gratitude habit training overview display, and one for an affirmation habit training overview display. Each of these habit training overview displays can include a time window, a daily count indicator, an amount of time indicator, and a selectable file icon that can allow users to select and view additional information about the particular habit. Also shown are selectable settings button and an add habit button. The settings button can allow a user to modify application settings when selected and the add habit button can allow a user to create a new habit when selected.

As shown in FIG. 3B, a user interface screen of a mobile application can include a habit creation screen. In the example embodiment, a user can enter a name or title for a habit, an alarm or reminder button to select or input a particular frequency that the reminder will occur (e.g., every 10 minutes), and one or more time window fields or dropdown menus that allow users to select when the reminder will be active (e.g., between 7:00 am and 7:00 pm). Also shown are a confirmation button that will create the selected habit reminder when selected and a back button that will take a user to a previous screen when selected. Those in the art will understand that reminders can occur in the form of device sounds, display notifications, vibrations, or other device indicators. In some embodiments indicators can be transmitted or set to occur on remote devices and may include network communication capability via a wired and/or wireless network over a protocol such as WI-FI, BLUETOOTH, or others via the Internet and/or other network.

As shown in FIG. 3C, a user interface screen of a mobile application can include the functionality to temporarily and/or permanently disable a particular habit training overview display. In the example embodiment, the user has selected a habit training overview display in the bottom right of the image. When selected the display changes to a dark shade and selectable buttons are shown to allow the user to disable or unselect the habit training overview display. If the user selects the disable button, the habit training overview display can turn a lighter shade to indicate that it is disable and show the normal information.

As shown in FIG. 4A, a user interface screen of a mobile application can include the functionality to enable a temporarily and/or permanently disabled habit training overview display.

In the example embodiment, the user has selected a habit training overview display in the bottom left of the image that was lightly shaded, indicating that it was disabled. When selected the display changes to a dark shade and selectable buttons are shown to allow a user to enable or unselect the habit training overview display. If the user selects the enable button, the habit training overview display can remove the shading and reestablish the normal functionality of the habit reminder.

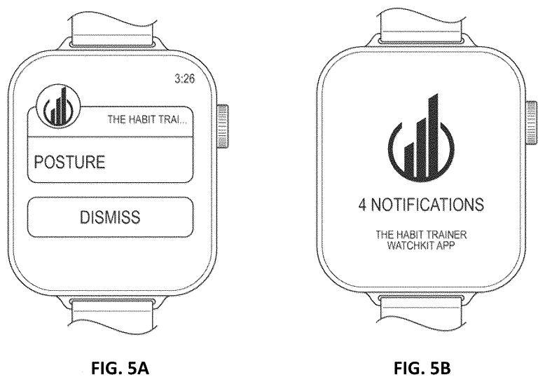

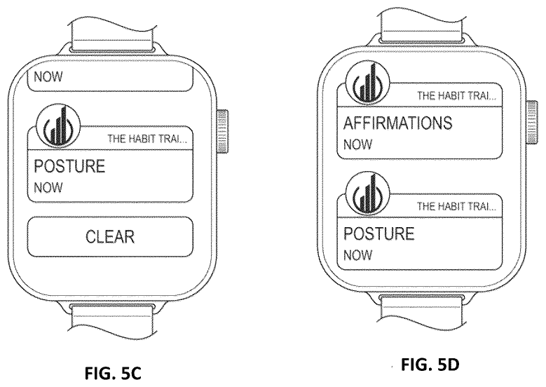

FIG. 5A-5D illustrate a user interface screen of a wearable device, according to some embodiments. In various embodiments, the functionality of wearable device habit trainers can be controlled by a user on a smartphone or other device that is communicatively coupled to the wearable device, such that the user can create, edit, and set habit reminders from the other device and they will be transmitted over a network to the wearable device.

As shown in FIG. 5A, a user interface screen of a wearable device can include a reminder title or name that is displayed when a particular timer setting has expired. It can include a selectable button or other feature allowing a user to dismiss the reminder. The user may tap the screen (or perform another action or gesture) to view all notifications that have been sent over a period of time.

As shown in FIG. 5B, if multiple reminders need to be displayed to the user or have not been dismissed, a notification indicating the number of habit reminders pending can be displayed.

As shown in FIG. 5C, a habit reminder can include a clear button in some embodiments that clears the display of the habit reminder.

As shown in FIG. 5D, a habit reminder can include multiple reminders in some embodiments, which can be individually selected and reviewed by the user.

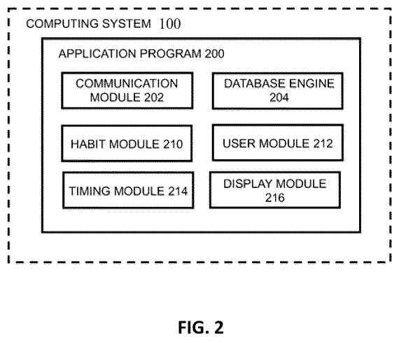

FIG. 2 illustrates an example computer architecture for the application program 200 operated via the computing system 100, also referred to as habit server. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a habit module 210, a user module 212, a timing module 214, a display module 216.

In some embodiments, the communication module 202 is configured for recelvmg, processing and transmitting a user command and/or one or more data streams. In such embodiments, the communication module 202 performs communication functions between various devices 180, including the user (habit former) computing device, the administrator (teacher/parent) computing device, a third-party (school) computing device, and the like. In some embodiments, communication module 202 is configured to allow one or more users of the system, including a third-party, to communicate with one another. In some embodiments, the communications module 202 is configured to maintain one or more communication sessions with one or more servers, the administrative computing device, and/or one or more third-party computing device(s).

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the habit module 210 is configured to receive user input related to a habit via the user interface. Each habit may be associated with a time window, a daily count indicator, an amount of time indicator, and a selectable file icon that can allow users to select and view additional information about the particular habit. Further, the user may input a predetermined number of habits (e.g., four). Selectable settings may be provided via habit selection buttons, customizable buttons, and/or add habit buttons. The settings button can allow a user to modify application settings when selected and the add habit button can allow a user to create a new habit when selected.

In some embodiments, may allow the user to create a habit via the user interface. a habit creation screen by allowing the user to enter a name or title for a habit, an alarm or reminder button to select or input a particular frequency that the reminder will occur (e.g., every 10 minutes), and one or more time window fields or dropdown menus that allow users to select when the reminder will be active (e.g., between 7:00 am and 7:00 pm).

In some embodiments, the user module 212 facilitates the creation of a user account for the application system. The user module 212 may allow the user to create a user profile which includes user information, habits, and other user settings. In some embodiments, the user module permits the user to input one or more preferences corresponding to the at least one habit and the time interval, wherein the at least one habit and the time interval is stored in the database.

The user module 212 may permit a third-party user to access the application program and thereby input habits which are transmitted to one or more additional users. For example, the third party user may be a school teacher who can input reminders for students to complete a task, habit, etc. The embodiments may be useful to teachers, coaches, parents, group leaders, etc.

In some embodiments, the timing module 214 is in operable communication with the computing device to permit the user to select a period of time for alerts to be transmitted, via the communication module 202. For example, alerts may be sent over regular time intervals (e.g., every 10 minutes) via one or more time window fields or dropdown menus that allow users to select.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 provides alerts to the user device which can be viewed and acknowledged (i.e., clicked, swiped, etc.) by the user.

In some embodiments, the display module is m operable communication with the communication module, the habit module, and the timing module to display the alert corresponding to the at least one habit, wherein the alert corresponding to the habit is displayed once the time interval has elapsed.

In some embodiments, habit days are tracked automatically such that once a habit block (i.e., a set of habits) is disabled, the tracking days function will stop until the user enables the habit block. Once the habit block is enabled, the tracking days function will restart. If the user erases or resets a habit word or phrase to start a new habit, the tracking days function will restart back to day 1.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A habit system for facilitating positive habit formation by students or athletes using a habit team approach, the habit system comprising:
a habit server comprising a processor, a memory, a data store, and computer code stored on the data store configured to be executed by the processor causing the habit system to:
establish a plurality of user accounts, each account being associated with an account holder, a computing device running habit code designed for interactions with the habit server, and security account access credentials unique to the respective one of the user accounts, wherein the user accounts comprise student, a teacher accounts, and parent accounts, wherein the teacher account is cross indexed and authorized access to a teacher subset of the student accounts comprising students of classes the teacher provides, wherein the parent accounts are cross indexed and authorized access to a parent subset of the student accounts associated with a child of the respective parent; and
define a plurality of habits for students to work upon, each of the habits comprising a daily habit training time window, a frequency in which the respective one of the habits is to be trained within the habit training time window, and a habit name, wherein at least one of the habits is defined by the teacher for the teacher each of the subset of student accounts; and
a plurality of student computing devices, each being a mobile device unique to one of the students in the teacher subset, each being configured to provides reminders for the respective one of the habits consistent with the frequency and the habit training time window, wherein each of the student computing devices is registered with the habit server and is associated with a respective one of the student accounts, wherein each reminder is associated with a confirmation that must be timely entered responsive to each of the reminders to be affirmed as successfully completed by the respective student,
wherein real time results from the habit server regarding whether the reminders have been successfully completed by the students are accessible from the teacher accounts for the teacher subset and are accessible from the parent accounts for the parent subset.

2. The system of claim 1, wherein the habit server is configured to communicate the real-time results to at least one school computer system utilized by the teacher within which student grades are maintained for the students including the subset that are taught by the teacher, wherein the real-time results are a factor that automatically affect grades per the student grades of the school computer system of the students of the teacher subset.

3. The system of claim 1, wherein the habits established by the teacher are academic habits desirable for students to possess for improved academic performance relative to students lacking such desirable academic habits.

4. The system of claim 1, wherein the student computing devices comprise smart phones of the students.

5. The system of claim 1, wherein the student computing devices comprise network connected wearable computing devices comprising at least smart watches.

6. The system of claim 1, wherein the habit server comprise an AI module configured to enable natural language processing via at least one chatbot interface, wherein each of the student computing devices comprise a habit application running on the respective computing devices providing natural language input and output dependent upon processing of the AI module and the chatbot interface.

7. The system of claim 6, wherein the chatbot interface permits questions of a habit knowledgebase maintained by the habit system for the habits established by the teachers, wherein the knowledgebase comprises machine learned and internet updated information for the habits established by the teachers.

8. The system of claim 6, wherein the AI module is an interface module that is made available to teachers utilizing the teacher accounts, parents using the parent accounts, and students utilizing the student accounts, each of which leverage a common habit knowledgebase trained for the AI module using machine learning (ML) and automated internet knowledge acquisitions.

9. The system of claim 1, wherein at least a portion of the reminders occur during a classroom period within which the subset of students are in the classroom of the teacher, wherein software executing on each of the student computing devices permits interactions for the limited purpose oof responding to reminders occurring during the classroom period, where other interactions during the classroom period are disabled or flagged as improper and conveyed to the habit server and available to the teacher via the respective teacher account.

10. The system of claim 1, wherein at least a portion of the students are public school students having a school acknowledged accommodation due to a student specific challenge, wherein the portion of students have an accommodation related habit defined within the habit server by a school administrator or school mental health professional, wherein the teacher is apprised of the accommodation related habit to an exist applicable to a classroom being taught by the teacher needs to be aware to facilitate the accommodation.

11. The system of claim 1, wherein the habits created by the teacher must be approved by the respective parents prior to such habits being applied to the respective students via the student computing devices.

12. A habit system for facilitating positive habit formation by using a habit team approach, the habit system comprising:
a habit server comprising a processor, a memory, a data store, and computer code stored on the data store configured to be executed by the processor causing the habit system to:
establish a plurality of user accounts, each account being associated with an account holder, a computing device running habit code designed for interactions with the habit server, and security account access credentials unique to the respective one of the user accounts; and
define a plurality of habits for students to work upon, each of the habits comprising a daily habit training time window, a frequency in which the respective one of the habits is to be trained within the habit training time window, and a habit name, wherein at least one of the habits is defined by a habit creator for a habit trainee, wherein the habit trainee has one of the user accounts, wherein the habit creator is not the habit trainee but is authorized to create the habits on behalf of the habit trainee and to monitor results from at least habits created by the habit creator; and
a plurality of trainee computing devices, each being a mobile device unique to one of the habit trainees, each being configured to provides reminders for the respective one of the habits consistent with the frequency and the habit training time window, wherein each of the trainee computing devices is registered with the habit server and is associated with a respective one of the user accounts, wherein each reminder is associated with a confirmation that must be timely entered responsive to each of the reminders to be affirmed as successfully completed by the respective habit trainee,
wherein real time results from the habit server regarding whether the reminders have been successfully completed by the habit trainee are accessible from the user account of the habit creator.

13. The system of claim 12, wherein the user accounts comprise student accounts, a teacher accounts, and parent accounts, wherein the teacher account is cross indexed and authorized access to a teacher subset of the student accounts comprising students of classes the teacher provides, wherein the parent accounts are cross indexed and authorized access to a parent subset of the student accounts associated with a child of the respective parent.

14. The system of claim 12, wherein the habit trainee is a child, wherein the habit creator is a parent.

15. The system of claim 12, wherein the habit trainee is a patient, wherein the habit creator is a mental health professional.

16. The system of claim 12, wherein the habit server comprise an AI module configured to enable natural language processing via at least one chatbot interface, wherein each of the trainee computing devices comprise a habit application running on the respective computing devices providing natural language input and output dependent upon processing of the AI module and the chatbot interface.

17. The system of claim 16, wherein the chatbot interface permits questions of a habit knowledgebase maintained by the habit system for the habits established by the habit creators, wherein the knowledgebase comprises machine learned and internet updated information for the habits established by the habit creators.

18. The system of claim 16, wherein the AI module is an interface module that is made available to habit creators and habit trainees utilizing the user accounts, each of which leverage a common habit knowledgebase trained for the AI module using machine learning (ML) and automated internet knowledge acquisitions.
